(19) United States
(12) Patent Application Publication
(10) Pub. No.: US 2022/0374752 A1
(43) Pub. Date: Nov. 24, 2022

(54) DECOMPOSITION OF TWO-QUBIT GATES

(71) Applicant: Alibaba Singapore Holding Private Limited, Singapore (SG)

(72) Inventors: Jiachen Huang, San Mateo, CA (US); Jianxin CHEN, Kirkland, WA (US)

(21) Appl. No.: 17/741,321

(22) Filed: May 10, 2022

Related U.S. Application Data
(60) Provisional application No. 63/187,560, filed on May 12, 2021.

(51) Int. Cl. G06N 10/20; G06N 10/80

(52) U.S. Cl. CPC G06N 10/20; G06N 10/80

(57) ABSTRACT

Systems, methods, and computer readable media for performing a quantum computation are disclosed. An exemplary system can include a quantum component and a classical component. The classical component can be configured to perform operations. The operations can include obtaining a description of a quantum computational task, generating a gate sequence implementing the quantum computational task, providing commands applying the gate sequence to the quantum component. and obtaining an output from the quantum component. Generation of the gate sequence can include identifying, in the gate sequence, a two-qubit gate applied to two qubits, determining a decomposition sequence that implements the two-qubit gate using at least one square root of iSWAP (SQiSW) gate and at least one single-qubit gate, and including the decomposition sequence in the gate sequence in place of the two-qubit gate.

### CROSS-REFERENCE TO RELATED APPLICATIONS

This application is a continuation of U.S. Non-Provisional Patent Application No. 63/187,560, filed on May 12, 2021, which is hereby incorporated by reference in its entirety.

### TECHNICAL FIELD

The present disclosure generally relates to quantum computing, and more particularly, to decomposition of arbitrary two-qubit gates into other gates.

### BACKGROUND

Quantum computing can address classically intractable computational problems. However, existing quantum computational devices are limited by various sources of error and imprecision. In particular, two-qubit gate operations constitute a major source of complex errors in existing quantum computational devices. Realization of an ultra-high fidelity two-qubit gate may improve the performance of quantum computing algorithms and advance the goal of fault-tolerant quantum computation for complex quantum-computational tasks.

### SUMMARY

The disclosed systems and methods relate to decomposition of two-qubit gates into square root of the iSWAP gate and single-qubit gates using, in part, a Cartan decomposition.

The disclosed embodiments include a system for performing a quantum computation. The system can include a quantum component and a classical component. The classical component can include at least one processor and at least one non-transitory computer-readable medium.

The at least one non-transitory computer-readable medium can contain instructions. When executed by the at least one processor, the instructions can cause the classical component to perform operations. The operations can include obtaining a description of a quantum computational task. The operations can further include generating a gate sequence implementing the quantum computational task. Generation of the gate sequence can include identifying, in the gate sequence, a two-qubit gate; determining a decomposition sequence that implements the two-qubit gate using at least one square root of iSWAP gate and at least one single-qubit gates; and including the decomposition sequence in the gate sequence in place of the two-qubit gate. The operations can further include providing commands applying the gate sequence to the quantum component and obtaining an output from the quantum component.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 depicts the Weyl chamber and the positions of common gates.

FIGS. 2A and 2B depict an exemplary method for decomposing an arbitrary two-qubit gate into a sequence of single-qubit gates and SQiSW gate(s) and exemplary pseudocode implementing the method, in accordance with disclosed embodiments.

FIG. 3 depicts generic decompositions of special and improper orthogonal gates, in accordance with disclosed embodiments.

FIG. 4 depicts a system for decomposing and applying sequences of quantum gates to implement a quantum computation, in accordance with disclosed embodiments.

FIG. 5 depicts an exemplary method for performing a quantum computational task using SQiSW gates and single-qubit gates, in accordance with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Quantum algorithms can be expressed in terms sequences of one or more quantum gates. An arbitrary quantum gate can be implemented using a sequence of other quantum gates. The particular quantum gates used to implement the arbitrary quantum gate can depend on the physical implementation of the quantum device (e.g., a particular physical implementation can be associated with one or more “native” quantum gates). The performance of the arbitrary quantum gate can depend on the performance of the native quantum gates used to implement the arbitrary quantum gate.

As described above, two-qubit gate operations constitute a major source of complex errors in existing quantum computational devices. The disclosed embodiments concern implementation of arbitrary two-quantum gates using a particular high-fidelity two-qubit quantum gate, the square root of the iSWAP gate (the SQiSW gate), in combination with other single-qubit quantum gates. The SQiSW gate has the unitary:

$$. SQiSW ≡ [ \begin{matrix}1 & 0 & 0 & 0 \\ 0 & \frac{1}{\sqrt{2}} & \frac{i}{\sqrt{2}} & 0 \\ 0 & \frac{i}{\sqrt{2}} & \frac{1}{\sqrt{2}} & 0 \\ 0 & 0 & 0 & 1\end{matrix} ] .$$

As disclosed herein, general quantum circuits can be implemented using SQiSW gates and single-qubit gates. In some embodiments, arbitrary two-qubit gates (and certain families of two-qubit gates) can be decomposed into sequences of SQiSW gates interleaved by single-qubit gates. The decomposition can be done efficiently on a classical computational device, and the compiled sequence can be readily run on an arbitrary quantum computational device supporting a native implementation of the SQiSW gate and arbitrary single-qubit gates.

For some computational tasks, an implementation using SQiSW gates and single qubit rotations can decrease the total number of quantum gates involved in the computational task, as compared to implementations using other two-qubit gates. Thus, implementation using SQiSW gates and single qubit rotations can have shorter gate sequences than conventional implementations, making the computational process more error resilient.

Independent of any decrease in the total gate count, the fast execution and high fidelity of the SQiSW gate can save time and result in higher overall fidelities for the implemented computational tasks, as compared to implementations using other two-qubit gates. Accordingly, the disclosed embodiments accelerate quantum computation, enabling larger-scale quantum computation and broader use cases for quantum computing.

A general two-qubit gate can be mathematically formulated as an element of the special unitary group S∪(4). Equivalence classes can be defined on S∪(4) using Cartan decomposition and the concept of the Weyl chamber. A two-qubit gate can be equivalent another two-qubit gate when the two gates differ by single-qubit correction gates. Thus an arbitrary two-qubit gate can be constructed from another two-qubit gate or collection of two-qubit gates and appropriate single qubit correction gates.

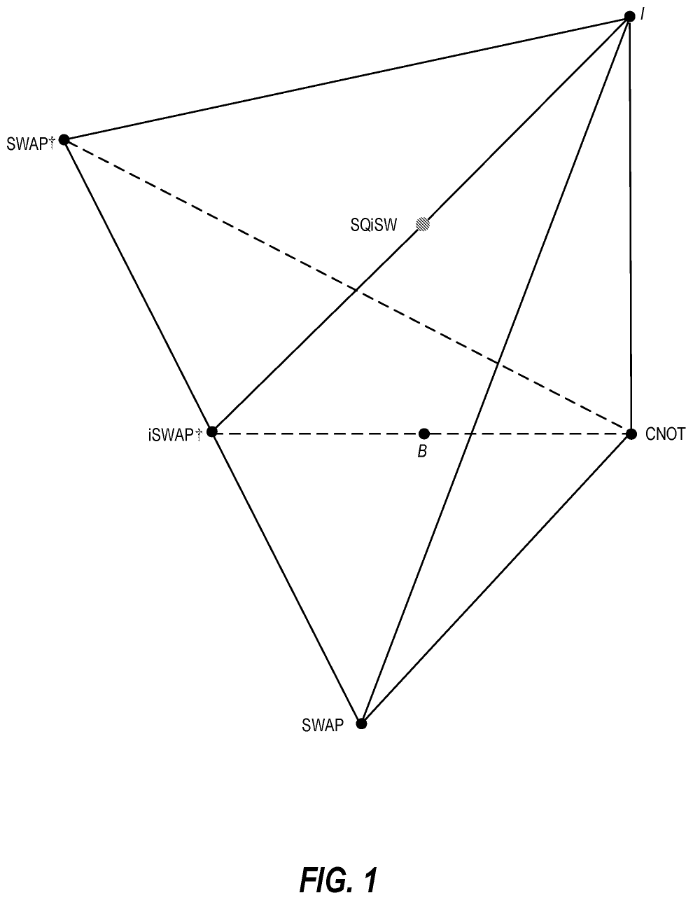

FIG. 1 depicts the Weyl chamber and the positions of common gates. Note that SQiSW lies in the midpoint of the identity and iSWAP. The point SWAP† is to be identified with the point SWAP but is drawn separately for easier visualization.

Theorem 1 (Cartan decomposition). For an arbitrary ∪ ∈ S∪(4), there exists a unique

$$\vec{η} = ( x , y , z ) , \frac{π}{4} \geq x \geq y \geq \vert z \vert ,$$

single qubit rotations A₀, A₁, B₀, B₁ ∈ S∪(2) and a global phase g ∈ {1, i} such that U=g (A₁⊗A₂) exp{i\vec{η} ·\vec{Σ} }(B₁⊗B₂), where \vec{Σ} ≡[σ_{X}⊗σ_{X}, σ_{Y}⊗σ_{Y}, σ_{Z}⊗σ_{Z}]. The tuple (g, \vec{η}, A₀, A₁, B₀, B₁) is called the Cartan (or KAK) decomposition of the unitary U.

The equivalence class of a unitary ∪ under local unitaries, denoted as ∪, is characterized by the interaction coefficients η(∪), which lives in a 3-dimensional tetrahedron called the Weyl chamber:

$$W ≡ \{ \frac{π}{4} \geq x \geq y \geq \vert z \vert \vert ( x , y , z ) ∈ {ℝ}^{3} \} .$$

Two unitaries ∪, V ∈ S∪(4) are locally equivalent, or ∪˜V, if η(∪)=η(V). Let L(x, y, z)≡exp(i[x, y, z]·\vec{Σ}) be the canonical element of the equivalence class. Then ∪˜L(η(∪)) for all ∪ ∈ S∪(4).

The single qubit rotations can be defined based on the following equations:

$${R}_{x} ( θ ) = [ \begin{matrix}cos ( θ ) & i sin ( θ ) \\ i sin ( θ ) & cos ( θ )\end{matrix} ] ,$$

$${R}_{y} ( θ ) = [ \begin{matrix}cos ( θ ) & sin ( θ ) \\ - s in ( θ ) & cos ( θ )\end{matrix} ] ,$$

$${R}_{z} ( θ ) = [ \begin{matrix}cos ( θ ) + i sin ( θ ) & 0 \\ 0 & cos ( θ ) - i sin ( θ )\end{matrix} ] .$$

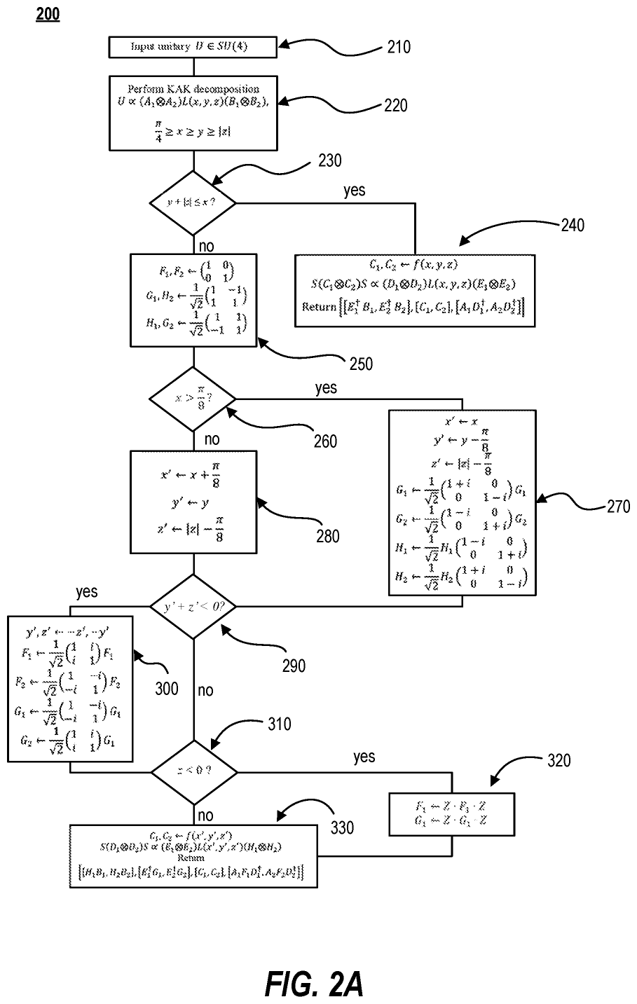

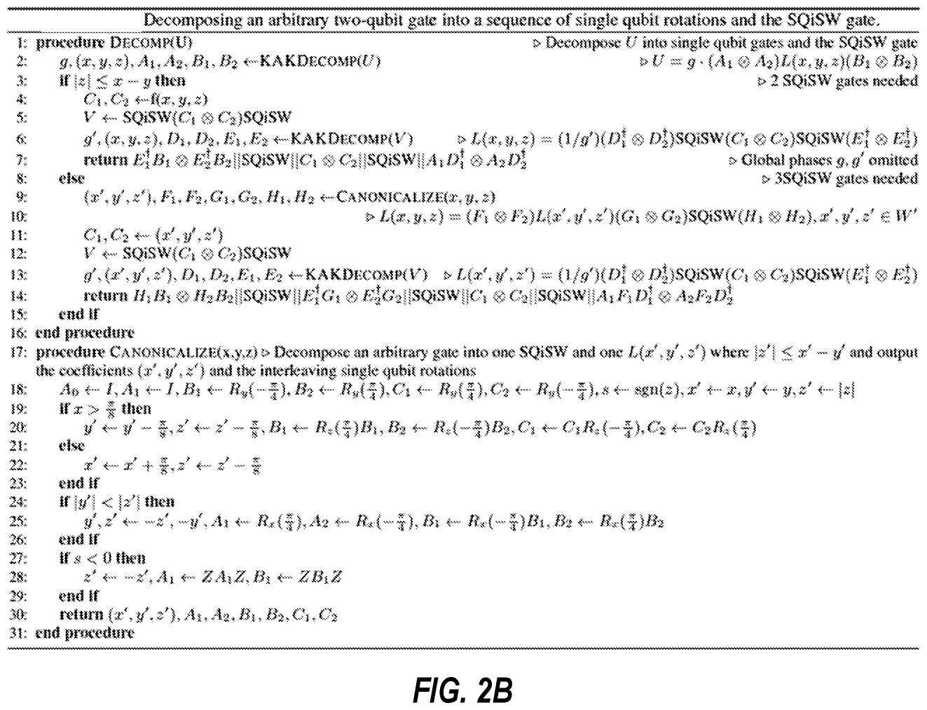

FIG. 2A depicts an exemplary method 200 for decomposing an arbitrary two-qubit gate into a sequence of single-qubit gates and SQiSW gate(s), in accordance with disclosed embodiments. FIG. 2B depicts a pseudocode implementation of method 200.

Method 200 can include obtaining a two-qubit gate in step 210. The two-qubit gate can be an arbitrary two-qubit gate. Method 200 can include performance of a KAK decomposition of the arbitrary two-qubit gate in step 220. If the interaction parameters of the arbitrary two-qubit gate satisfy a Weyl condition in step 230, then the two-qubit gate can be implemented using two SQiSW gates according to the formulation given in step 240.

Otherwise, the two-qubit gate can be implemented using three SQiSW gates. The interaction parameters can be canonicalized, decomposing the arbitrary gate into an SQiSW gate, a canonical element corresponding to interaction parameters that satisfy the Weyl condition, and local gates. In step 250, the local gates can be initialized. In step 260, based on the value of the original x interaction parameter the values of the interaction parameters and the local gates can be updated (in step 270) or the values of the interaction parameters can be updated (in step 280). In step 290, based on the updated values of the y and z interaction parameters, the interaction parameters and the local gates can be updated (in step 300). In step 310, based on the sign of the original z parameters, the z interaction parameter and certain local gates can be updated in step 320. The two-qubit gate can then be implemented using three SQiSW gates according to the formulation given in step 330.

In the depicted decompositions of FIGS. 2A and 2B:

$$f ( x , y , z ) = ( \begin{matrix}{e}^{i γ} cos α & i sin α \\ i sin α & {e}^{- i γ} cos α\end{matrix} ) '$$

$$g ( x , y , z ) = ( \begin{matrix}cos β & i sin β \\ i sin β & cos β\end{matrix} ) ,$$

$$α = \frac{1}{2} arc cos ( cos 2 x - cos 2 y + cos 2 z + 2 \sqrt{C} ) ,$$

$$β = \frac{1}{2} arc cos ( cos 2 x - cos 2 y + cos 2 z + 2 \sqrt{C} ) ,$$

$$γ = arc cos ( sgn z \cdot \sqrt{\frac{4 {cos}^{2} x {cos}^{2} z {sin}^{2} y}{4 {cos}^{2} x {cos}^{2} z {sin}^{2} y + cos 2 x cos {2}^{} y cos 2 z}} ) ,$$

$$C = sin ( x + y - z ) sin ( x - y + z ) sin ( - x - y - z ) sin ( - x + y + z ) .$$

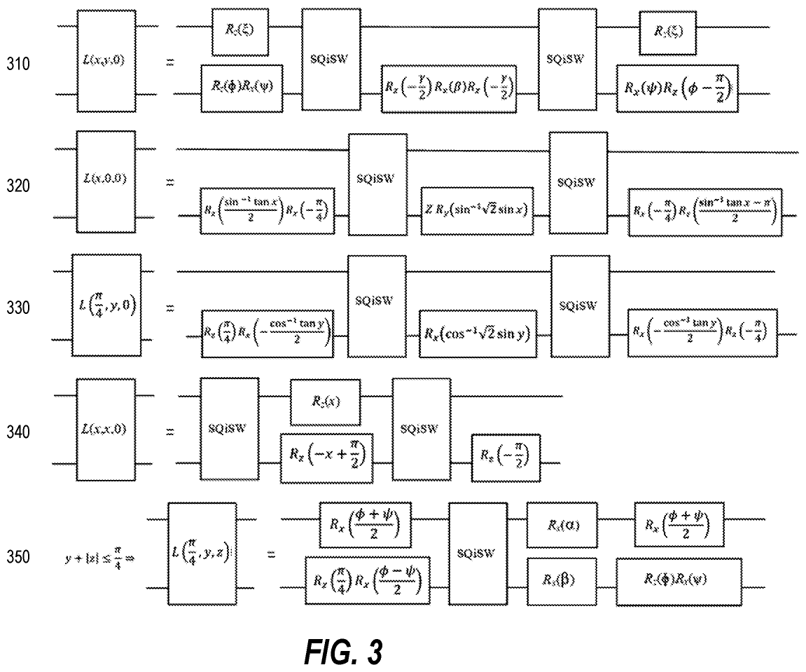

Applying method 200, certain families of quantum gates can be represented in terms of generic sequences of single-qubit gates and SQiSW gate(s). FIG. 3 depicts generic decompositions of special and improper orthogonal gates, in accordance with disclosed embodiments.

Consistent with disclosed embodiments, special orthogonal gates can involve arbitrary X and Y rotations, but not Z rotations. Decomposition 310 depicts an exemplary decomposition of such a special orthogonal gate into single-qubit gates and SQiSW gates. Gates locally equivalent to special orthogonal gates in SO(4) (e.g., gates that lie in the I—CNOT—iSWAP plane) can be generated using two or more SQiSW gates. Moreover, for such gates, the expressions of α, β, γ can be simplified as:

$$α = 0 ,$$

$$β = arc cos \sqrt{cos 2 x + 2 {sin}^{2} y} ,$$

$$γ = arc cos \sqrt{\frac{4 {cos}^{2} x {sin}^{2} y}{cos 2 x + 2 {sin}^{2} y}} .$$

Therefore, the gauge freedom can be applied to check that:

L(x,y,z)˜SQiSW·(I⊗B)·SQiSW,

where

$$\begin{matrix}B = {R}_{z} ( - \frac{γ}{2} ) {R}_{x} ( β ) {R}_{z} ( - \frac{γ}{2} ) \\ = [ \begin{matrix}2 cos x sin y - i \sqrt{cos 2 x cos 2 y} & i \sqrt{cos 2 y - cos 2 x} \\ i \sqrt{cos 2 y - cos 2 x} & 2 cos x sin y + i \sqrt{cos 2 x cos 2 y}\end{matrix} ] .\end{matrix}$$

In the case of special orthogonal gates, the single qubit corrections can be solved analytically. Let

$$ξ ≡ - \frac{1}{2} arc sin ( sin y \cdot \sqrt{\frac{2 cos 2 x}{cos 2 x + cos 2 y}} ) ,$$

$$β ≡ \frac{1}{2} arc cos ( - cos y \cdot \sqrt{\frac{2 cos 2 x}{cos 2 x + cos 2 y}} ) ,$$

$$ψ ≡ \frac{1}{2} arc cos ( cot ( x ) tan ( y ) ) .$$

Then

$$L ( x , y , 0 ) = ( {R}_{z} ( ξ ) ⊗ {R}_{z} ( ϕ ) {R}_{x} ( ψ ) ) \cdot SQiSW \cdot ( l ⊗ B ) \cdot SQiSW \cdot ( {R}_{z} ( ξ ) ⊗ {R}_{x} ( ψ ) {R}_{z} ( ϕ - \frac{π}{2} ) ) .$$

Specific examples of special orthogonal gates include CPHASE family, the super-controlled gate family, and the iSWAP family. Decomposition 320 depicts an exemplary decomposition of a gate in the CPHASE family (x, 0,0), where B=ZR_{y}(arcsin(\sqrt{2} sin x)). Decomposition 330 depicts an exemplary decomposition of a gate in the super-controlled gate family

$$( \frac{π}{4} , y , 0 ) ,$$

where B=Rₓ(arccos(\sqrt{2} sin y)). Decomposition 340 depicts an exemplary decomposition of a gate in the iSWAP Family (x, x, 0), where

$$B = {R}_{z} ( 2 x - \frac{π}{2} ) .$$

Consistent with disclosed embodiments, improper orthogonal gates can involve X rotations of

$$\frac{π}{4}$$

and arbitrary Y and Z rotations. As depicted by decomposition 350, improper orthogonal gates can be generated by 2 SQiSW gates when y+|z|≤π/4. In this case, one has:

$$α = \frac{1}{2} arc cos ( cos 2 z - cos 2 y + \sqrt{\frac{cos 4 z + cos 4 y}{2}} ) ,$$

$$β = \frac{1}{2} arc cos ( cos 2 z - cos 2 y - \sqrt{\frac{cos 4 z + cos 4 y}{2}} ) ,$$

$$γ = 0.$$

Therefore,

$$L ( \frac{π}{4} , y , z ) ∼ SQiSW \cdot ( {R}_{x} ( α ) ⊗ {R}_{x} ( β ) ) \cdot SQiSW .$$

In this case, the single qubit corrections can be explicitly found. Let

$$ϕ = - arc cos \sqrt{\frac{1 + tan ( y - z )}{2}} ,$$

$$ψ = arc cos \sqrt{\frac{1 + tan ( y + z )}{2} ,}$$

then

$$L = ( \frac{π}{4} , y , z ) = ( {R}_{x} ( \frac{ϕ + ψ}{2} ) ⊗ {R}_{z} ( \frac{π}{4} ) {R}_{x} ( \frac{ϕ - ψ}{2} ) ) \cdot SQiSW \cdot ( {R}_{x} ( α ) ⊗ {R}_{x} ( β ) ) \cdot SQiSW \cdot ( {R}_{x} ( \frac{ϕ + ψ}{2} ) ⊗ {R}_{x} ( \frac{ϕ - ψ}{2} ) {R}_{z} ( - \frac{π}{4} ) ) .$$

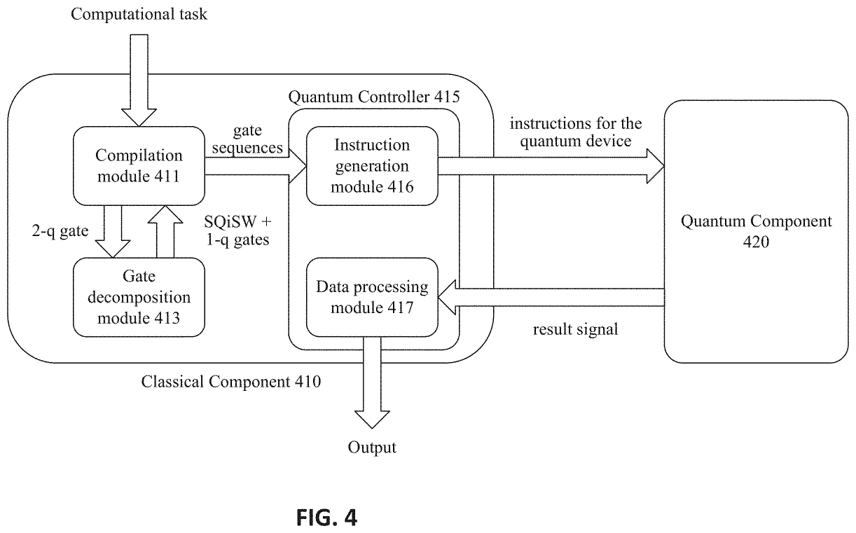

FIG. 4 depicts a system 400 for decomposing and applying sequences of quantum gates to implement a quantum computation, in accordance with disclosed embodiments. The system 400 can include a classical component 410 (e.g., a classical computing device, or collection of classical computing devices) and a quantum component 420.

Quantum component 420 can be configured to process information using quantum phenomena (e.g., superposition or entanglement). Quantum component 420 can operate on units of information referred to as “qubits” or simply “qubits.” A qubit is the smallest unit of information in quantum computers, and can have any linear combination of two values, usually denoted 10 [symbol] and |1 [symbol] . The value of the qubit can be denoted |ψ [symbol] . Different from a digital bit that can have a value of either “0” or “1,” |ψ [symbol] can have a value of α|0 [symbol] +β|1 [symbol] where α and β are complex numbers (referred to as “amplitudes”) not limited by any constraint except |α|²+|β|²=1. Qubits can be constructed in various forms and can be represented as quantum states of components of quantum component 420. For example, a qubit can be physically implemented using photons (e.g., in lasers) with their polarizations as the quantum states, electrons or ions (e.g., trapped in an electromagnetic field) with their spins as the quantum states, Josephson junctions (e.g., in a superconducting quantum system) with their charges, current fluxes, or phases as the quantum states, quantum dots (e.g., in semiconductor structures) with their dot spin as the quantum states, topological quantum systems, or any other system that can provide two or more quantum states. Quantum component 420 can apply quantum logic gates (or simply “quantum gates”) to create, remove, or modify qubits.

In contrast, classical component 410 can be computing system that cannot perform quantum computations, such as an electronic computer (e.g., a laptop, desktop, cluster, cloud computing platform, or the like). Classical component 410 can operate in digital logic on binary-valued bits. Classical component 410 can include one or more processors (e.g., CPUs, GPUs, or the like), application specific integrated circuits, hardware accelerators, or other components for processing digital logic. Classical component 410 can include one or more memories, buffers, caches, or other components for storing binary values. Classical component 410 can include one or more I/O devices of communicating with other systems, devices (e.g., quantum component 420), users, or the like.

The classical component 410 can be configured to control the quantum device 420. The classical component can include a compilation module 411. Compilation module 411 can be configured to obtain a description of a quantum computation task (a unitary, a quantum circuit, etc.) and determine an implementation of the quantum computation task. The implementation can be a gate sequence. The gate sequence can include SQiSW gates and single-qubit gates.

In some embodiments, gate decomposition module 413 (which may be implemented as a submodule of compilation module 411) can be configured to decompose a given two-qubit gate into a sequence of SQiSW gates and single qubit gates, using the methods described herein (e.g., method 200, as described with regards to FIGS. 2A and 2B). Gate decomposition module 413 can obtain a two-qubits gate from compilation module 411. In response, gate decomposition module 413 can determine and provide to compilation module 411 a sequence of SQiSW gates and single qubit gates that implement the obtained two-qubits gate.

Quantum controller 415 can be configured to directly control quantum component 420. Quantum controller 415 can be a digital computing device (e.g., a computing device including a central processing unit, graphical processing unit, application specific integrated circuit, field-programmable gate array, or other suitable processor). Quantum controller 415 can configure quantum component 420 for computation, provide quantum gates to, and read state information out of quantum circuit 420.

Quantum controller 415 can include an instruction generation module 416. Instruction generation module 416 can be configured to directly or indirectly provide bias drives to quantum circuit 420 to enable or disable interactions between qubits. Instruction generation module 416 can indirectly provide bias drives by providing instructions to a bias drive source (e.g., waveform generator or the like), causing the bias drive source to provide the bias drives to circuit 420. Instruction generation module 416 can apply quantum gates by providing one or more microwave pulses (or other gate drives) to qubits in quantum component 420. In various embodiments, Instruction generation module 416 can implement such gates by providing instructions to a computation drive source (e.g., a waveform generator or the like), causing the computational drive source to provide such microwave pulses (or other gate drives) to qubits in quantum component 420. The microwave pulses can be selected or configured to implement one or more quantum gates, as described herein. The microwave pulses can be provided to qubits using one or more coils coupled to the corresponding qubits. The coils can be external to quantum component 420 or on a chip implementing quantum component 420.

Quantum controller 415 can be configured to determine state information for quantum component 420. In some embodiments, quantum controller 415 can measure a state of one or more qubits of quantum component 420. The state can be measured upon completion of a sequence of one or more quantum operations. In some embodiments, instruction generation module 416 can provide a probe signal (e.g., a microwave probe tone) to a coupled resonator of quantum component 420, or provide instructions to a readout device (e.g., an arbitrary waveform generator) that provides the probe signal.

In various embodiments, quantum controller 415 can include a data processing module 417. Data processing module 417 can take the output signal (e.g., electrical/photonic), transforms it into discrete signals, and do data processing on it (e.g., averaging, post-processing) to obtain a computational result. In some embodiments, data processing module 417 can include, or be configured to receive information from, a detector configured to determine an amplitude and phase of an output signal received from the coupled resonator in response to provision of the microwave probe tone. The amplitude and phase of the output signal can be used to determine the state of the probed qubit(s). The disclosed embodiments are not limited to any particular method of measuring the state of the qubits.

Quantum component 420 can be configured to receive commands (e.g., bias drives, quantum gates, probe signal, or the like) from the classical component 410. In some embodiments, quantum component 420 can be implemented using a superconducting quantum circuit coupled to quantum controller 415 using at least one microwave drive line. The superconducting quantum circuit can implement multiple qubits (e.g., transmon qubits, fluxonium qubits, or any other suitable type of qubit), consistent with disclosed embodiments. In some embodiments, the superconducting quantum circuit can be realized using one or more chips containing the qubits, each of the chip(s) including at least a portion of the microwave drive line(s) coupling the qubit(s) to quantum controller 415.

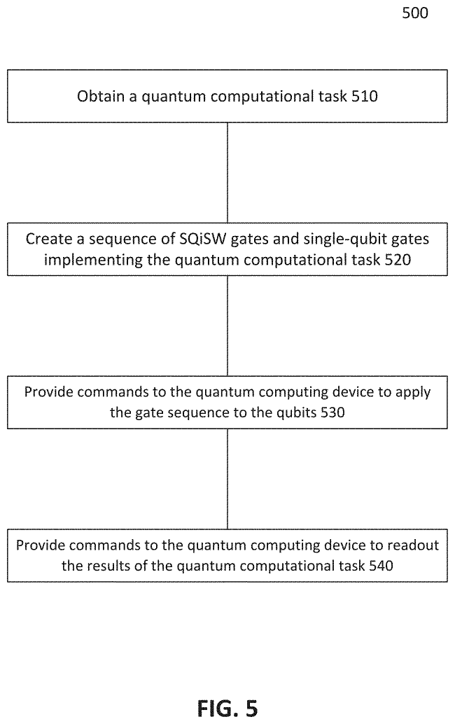

FIG. 5 depicts an exemplary method 500 for performing a quantum computational task using SQiSW gates and single-qubit gates, in accordance with disclosed embodiments. In some embodiments, method 500 can be performed using system 400. Method 500 can include operations performed on a conventional computing device (e.g., a mobile device, laptop, desktop, workstation, computing cluster, cloud-computing platform, or the like) such as classical component 410. Method 500 can include operations performed on a quantum computing device (e.g., a quantum controller managing a superconducting circuit, trapped ion quantum systems, topological quantum computing systems, photonic quantum computing systems, or the like) such a quantum component 420. A gate sequence can be generated by the conventional computing device. The conventional computing device can provide instructions configuring the quantum computing device to apply the gate sequences to an appropriate arrangement of qubits. The quantum computing device can perform the quantum computational task by applying the gate sequence. The conventional computing device can then provide instructions to the quantum computing device to read out the results of the quantum computational task.

In step 510, the conventional computing device can obtain a description of a quantum computational task. Such a description can specify a task by type, inputs, parameters, or the like. The disclosed embodiments are not limited to any particular format or manner of describing a quantum task.

In step 520, the conventional computing device can create a sequence of SQiSW gates and single-qubit gates implementing the quantum computational task. In some embodiments, the conventional computing device can create a first implementation of the quantum computational task as a sequence of arbitrary two-qubit gates. Consistent with disclosed embodiments, each two-qubit gate can then be decomposed into a gate sequence including a number of SQiSW gates and interleaving single qubit gates. The decomposition can satisfy an optimality condition: it can be shown that the decomposition requires a minimum number of SQiSW gates when compiling an arbitrary two-qubit gate.

In step 530, the conventional computing device can provide commands to the quantum computing device (e.g., quantum component 420) to apply the gate sequence to the appropriate arrangement of qubits. The quantum computing device can implement the quantum computational task by applying the gate sequence to the qubits.

In step 540, the conventional computing device can provide commands to the quantum computing device to readout the results of the quantum computational task.

The disclosed embodiments are not limited to embodiments including a quantum computing device. In some embodiments, application of the gate sequence to the appropriate arrangement of qubits can be simulated by the original conventional computing device or another, separate conventional computing device. For example, the gate sequence could be generated on a laptop and application of the gate sequence could be stimulated using a cloud-computing platform. Upon completion of the simulation, the simulation results could be provided to the original conventional computing device.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation or restriction of the scope of the embodiments, the scope being defined by the following claims.

What is claimed is:

1. A system for performing a quantum computation comprising:
a quantum component; and
a classical component, the classical component including at least one processor, and at least one non-transitory computer-readable medium containing instructions that, when executed by the at least one processor, cause the classical component to perform operations comprising:
obtaining a description of a quantum computational task;
generating a gate sequence implementing the quantum computational task, generation comprising:
identifying, in the gate sequence, a two-qubit gate applied to two qubits;
determining a decomposition sequence that implements the two-qubit gate using at least one square root of iSWAP (SQiSW) gate and at least one single-qubit gate; and
including the decomposition sequence in the gate sequence in place of the two-qubit gate; and
providing commands applying the gate sequence to the quantum component and obtaining an output from the quantum component.

2. The system of claim 1, wherein:
determining a decomposition sequence comprises performing a Cartan decomposition of a unitary of the two-qubit gate.

3. The system of claim 1, wherein:
the decomposition includes two SQiSW gates when the two-qubit gate is, or is locally equivalent to, a special orthogonal gate.

4. The system of claim 1, wherein:
the at least one single-qubit gate comprises three single-qubit gates and the decomposition specifies application of the three single-qubit gates to one of the two qubits when the two-qubit gate is, or is locally equivalent to, a CPHASE gate or super-controlled gate.

5. The system of claim 1, wherein:
the at least one single-qubit gate comprises three single-qubit gates and the decomposition specifies application of a first one of the three single-qubit gates to a first one of the two qubits and application of a second and a third one of the three single-qubit gates to a second one of the two qubits when the two-qubit gate is, or is locally equivalent to, an iSWAP gate.

6. The system of claim 1, wherein:
the decomposition specifies application of one SQiSW gate when the two-qubit gate is, or is locally equivalent to, an improper orthogonal gate.

7. The system of claim 1, wherein:
determining the decomposition sequence comprises analytically determining the at least one single-qubit gate.

8. The system of claim 1, wherein:
the decomposition sequences comprises:
two single qubit correction gates R1 and R2 respectively applied to a first and second qubit;
a first SQiSW gate applied to the first and second qubits following application of the two single qubit correction gates R1 and R2;
a single qubit correction gate R3 applied to the second qubit following application of the first SQiSW gate;
a second SQiSW gate applied to the first and second qubits following application of the single qubit correction gate R3; and
two single qubit correction gates R4 and R5 respectively applied to the first and second qubit following application of the second SQiSW gate.

9. The system of claim 1, wherein:
the decomposition sequences comprises:
a single qubit correction gate R1 applied to a second qubit;
a first SQiSW gate applied to a first qubit and the second qubit following application of the single qubit correction gate R1;
a single qubit correction gate R2 applied to the second qubit following application of the first SQiSW gate;
a second SQiSW gate applied to the first and second qubits following application of the single qubit correction gate R2; and
a single qubit correction gates R3 applied to the second qubit following application of the second SQiSW gate.

10. The system of claim 1, wherein:
the decomposition sequences comprises:
a first SQiSW gate applied to first and second qubits;
two single qubit correction gates R1 and R2 respectively applied to the first and second qubit following application of the first SQiSW gate;
a second SQiSW gate applied to the first and second qubits following application of the two single qubit correction gates R1 and R2; and
a single qubit correction gates R3 applied to the second qubit following application of the second SQiSW gate.

11. The system of claim 1, wherein:
the decomposition sequences comprises:
two single qubit correction gates R1 and R2 respectively applied to the first and second qubit;
a first SQiSW gate applied to the first and second qubits following application of the two single qubit correction gates R1 and R2;
two single qubit correction gates R3 and R5 applied to the first qubit following application of the first SQiSW gate; and
two single qubit correction gates R4 and R6 applied to the second qubit following application of the first SQiSW gate.

12. A non-transitory, computer-readable medium containing instructions that, when executed by at least one processor, cause a system to perform operations comprising:
obtaining a description of a quantum computational task;
generating a gate sequence implementing the quantum computational task, the generating comprising:
identifying, in the gate sequence, a two-qubit gate applied to two qubits;
determining a decomposition sequence that implements the two-qubit gate using at least one square root of iSWAP (SQiSW) gate and at least one single-qubit gate; and
including the decomposition sequence in the gate sequence in place of the two-qubit gate; and
providing commands applying the gate sequence to a quantum computer and obtaining an output from the quantum computer.

13. The non-transitory, computer-readable medium of claim 1, wherein:
determining a decomposition sequence comprises performing a Cartan decomposition of a unitary of the two-qubit gate.

14. The non-transitory, computer-readable medium of claim 1, wherein:
the decomposition includes two SQiSW gates when the two-qubit gate is, or is locally equivalent to, a special orthogonal gate.

15. The non-transitory, computer-readable medium of claim 1, wherein:
the at least one single-qubit gate comprises three single-qubit gates and the decomposition specifies application of the three single-qubit gates to one of the two qubits when the two-qubit gate is, or is locally equivalent to, a CPHASE gate or super-controlled gate.

16. The non-transitory, computer-readable medium of claim 1, wherein:
the at least one single-qubit gate comprises three single-qubit gates and the decomposition specifies application of a first one of the three single-qubit gates to a first one of the two qubits and application of a second and a third one of the three single-qubit gates to a second one of the two qubits when the two-qubit gate is, or is locally equivalent to, an iSWAP gate.

17. The non-transitory, computer-readable medium of claim 1, wherein:
the decomposition specifies application of one SQiSW gate when the when the two-qubit gate is, or is locally equivalent to, an improper orthogonal gate.

18. The non-transitory, computer-readable medium of claim 1, wherein:
determining the decomposition sequence comprises analytically determining the at least one single-qubit gate.

19. A method, comprising:
obtaining a description of a quantum computational task;
generating a gate sequence implementing the quantum computational task, the generating comprising:
identifying, in the gate sequence, a two-qubit gate applied to two qubits;
determining a decomposition sequence that implements the two-qubit gate using at least one square root of iSWAP (SQiSW) gate and at least one single-qubit gate; and
including the decomposition sequence in the gate sequence in place of the two-qubit gate; and
providing commands applying the gate sequence to a quantum computer and obtaining an output from the quantum computer.

20. The method of claim 1, wherein:
determining a decomposition sequence comprises performing a Cartan decomposition of a unitary of the two-qubit gate.
